(19) United States
(12) Patent Application Publication
(10) Pub. No.: US 2016/0129707 A1
(43) Pub. Date: May 12, 2016

(54) PRINTING APPARATUS AND PRINTING METHOD

(71) Applicant: SEIKO EPSON CORPORATION, Tokyo (JP)

(72) Inventor: Kenji KOJIMA, Fujimi-machi (JP)

(21) Appl. No.: 14/924,887

(22) Filed: Oct. 28, 2015

(30) Foreign Application Priority Data
Nov. 7, 2014 (JP) 2014-227460

(51) Int. Cl. B41J 13/00; B65H 20/02; B65H 20/06; B65H 43/08

(52) U.S. Cl. CPC B41J 13/0009; B65H 43/08; B65H 20/02; B65H 20/06

(57) ABSTRACT

A printing apparatus includes a transport mechanism portion that transports a work of a sheet shape; a printing mechanism portion that is disposed so as to face, across a space, the work being in a state of being transported by the transport mechanism portion and that includes a set of ink jet heads from which inks are ejected and thereby printing is performed onto the work; and a control portion that determines whether or not the transport of the work is to be allowed, on the basis of an upper face position of the work and a distance of the space.

### BACKGROUND

1. Technical Field

The present invention relates to a preprinting apparatus and a printing method.

2. Related Art

Heretofore, a printing apparatus that performs printing by discharging an ink onto a recording medium has been widely used (refer to, for example, JP-A-2006-239866). A printing apparatus disclosed in JP-A-2006-239866 includes a transport means that transports a recording medium; an ink jet head that eject an ink onto the recording medium having been transported; a textile thickness detection means that detects the height of a recorded face of the recording medium that is in a state of being transported by the transport means; and a movement means that change the height of the ink jet head in accordance with the height of the recorded face of the textile, having been detected by the textile thickness detection means.

Such a printing apparatus is configured such that a threshold value of the height of the recorded face of the recording medium is set in advance, and the height of the ink jet head is adjusted when the height of the recorded face of the recording medium exceeds the threshold value.

In such a configuration, however, the setting of the threshold value of the height of the recorded face of the recording medium is generally set by an operator in accordance with the thickness of the recording medium. Thus, an incorrect threshold value is likely to be set on a recording medium due to a mistake in an operator's input of the threshold value. When an incorrect threshold value is set, a to-be-detected prominent portion, such as a wrinkle or a seam, is not detected and, as a result, printing is performed on such a to-be-detected prominent portion in a state in which the height of the ink jet head remains unadjusted; thereby causing the possibility of a failure in printing.

### SUMMARY

An advantage of some aspects of the invention is that a printing apparatus and a printing method are provided, which make it possible to prevent a mistake in an operator's input operation.

Such a printing apparatus and a printing method can be realized as the following application examples and embodiments.

### Application Example 1

A printing apparatus according to this application example includes a transport portion that transports a recording medium of a sheet shape; a printing portion that is disposed so as to face, across a space, the recording medium being in a state of being transported by the transport portion and that includes a plurality of nozzles through which inks are ejected and thereby printing is performed onto the recording medium; and a determination portion that determines whether or not the transport of the recording medium is to be allowed, on the basis of an upper face position of the recording medium and a distance of the space.

Through this configuration, a determination reference value, in accordance with which it is determined whether or not the transport of the recording medium is to be allowed, is automatically set on the basis of the upper face position of the recording medium and the distance of the space. Thus, this configuration makes it possible to prevent a mistake in an operator's operation of inputting the determination reference value.

### Application Example 2

The printing apparatus according to the above application example preferably further includes a detection portion that is disposed at a more upstream position than the plurality of nozzles in a transport direction in which the recording medium is transported, and that detects the upper face position.

This configuration enables the printing apparatus to detect the upper face position of the recording medium, and thereby makes it possible to prevent a mistake in an operator's operation of inputting the upper face position.

### Application Example 3

In the printing apparatus according to the above application example, preferably, the transport of the recording medium is allowed when the upper face position having been detected by the detection portion is within a predetermined range, and the transport of the recording medium is inhibited when the upper face position having been detected by the detection portion is out of the predetermined range.

This configuration enables the printing apparatus to accurately determine whether or not the transport of the recording medium is to be allowed.

### Application Example 4

In the printing apparatus according to the above application example, the recording medium forms a belt shape and is transported in a direction along a long side of the recording medium. Further, preferably, the detection portion is constituted by a sensor that detects a received light amount of light entering in a direction along a width of the recording medium.

This configuration enables the printing apparatus to accurately detect the upper face position of the recording medium.

### Application Example 5

In the printing apparatus according to the above application example, the recording medium forms a belt shape and is transported in a direction along a long side of the recording medium. Further, preferably, the detection portion is constituted by a first sensor that detects a received light amount of reflection light having been reflected at the recording medium, and a second sensor that detects a received light amount of light entering in a direction along a width of the recording medium.

This configuration makes it possible to increase the accuracy in both of the detection operations each performed by a corresponding one of the first sensor and the second sensor.

### Application Example 6

In the printing apparatus according to the above application example, preferably, the first sensor is a sensor that detects the upper face position before starting of a recording operation performed by the printing apparatus, and the second sensor is a sensor that detects the upper face position during the printing operation performed by the printing operation.

This configuration makes it possible to increase the accuracy in both of the detection operations each performed by a corresponding one of the first sensor and the second sensor.

### Application Example 7

In the printing apparatus according to the above application example, preferably, each of the first sensor and the second sensor is a reflection type sensor.

This configuration makes it possible to simplify the configuration of the printing apparatus.

### Application Example 8

The printing apparatus according to the above application example preferably further includes an adjustment portion for adjusting a height of the plurality of nozzles.

This configuration makes it possible to adjust the height of the plurality of nozzles in accordance with the upper face position of the recording medium.

### Application Example 9

In the printing apparatus according to the above application example, preferably, the control portion corrects the upper face position of the recording medium on the basis a material of the recording medium.

This configuration enables the printing apparatus to set the upper face position of the recording medium in a way that does not depend on the material of the recording medium and thus leads to a nearly maximum degree of accuracy in the setting of the upper face position.

### Application Example 10

A printing method according to this application example is a printing method for use in printing using a transport portion that transports a recording medium of a sheet shape, and a printing portion that is disposed so as to face, across a space, the recording medium being in a state of being transported by the transport portion, and that includes a plurality of nozzles through which inks are ejected and thereby printing is performed onto the recording medium. Further, this printing method includes a determination process of determining whether or not the transport of the recording medium is to be allowed, on the basis of an upper face position of the recording medium and a distance of the space.

Through this configuration, a determination reference value, in accordance with which it is determined whether or not the transport of the recording medium is to be allowed, is automatically set on the basis of the upper face position of the recording medium and the distance of the space. Thus, this configuration makes it possible to prevent a mistake in an operator's operation of inputting the determination reference value.

### BRIEF DESCRIPTION OF THE DRAWINGS

The invention will be described with reference to the accompanying drawings, wherein like numbers reference like elements.

FIG. 1 is side view schematically illustrating a printing apparatus according to a first embodiment of the invention.

FIG. 2 is a block diagram of a printing apparatus illustrated in FIG. 1.

FIG. 3 is a diagram illustrating a printing apparatus illustrated in FIG. 1 when the printing apparatus is viewed in a direction indicated by the arrow III of FIG. 1.

FIG. 4 is a diagram that describes operation of a printing apparatus illustrated in FIG. 1.

FIG. 5 is a diagram that describes operation of a printing apparatus illustrated in FIG. 1.

FIG. 6 is a diagram that describes operation of a printing apparatus illustrated in FIG. 1.

FIG. 7 is a diagram that describes operation of a printing apparatus illustrated in FIG. 1.

FIG. 8 is a diagram that describes operation of a printing apparatus illustrated in FIG. 1.

FIG. 9 is a diagram that describes operation of a printing apparatus illustrated in FIG. 1.

FIG. 10 is a diagram that describes operation of a printing apparatus illustrated in FIG. 1.

FIG. 11 is a diagram that describes operation of a printing apparatus shown in FIG. 1.

FIG. 12 is a diagram that describes operation of a printing apparatus illustrated in FIG. 1.

FIG. 13 is a diagram that describes operation of a printing apparatus illustrated in FIG. 1.

FIG. 14 is a diagram that describes operation of a printing apparatus shown in FIG. 1.

FIG. 15 is a diagram that describes operation of a printing apparatus illustrated in FIG. 1.

FIG. 16 is a diagram that describes operation of a printing apparatus shown in FIG. 1.

FIG. 17 is a diagram that describes operation of a printing apparatus illustrated in FIG. 1.

FIG. 18 is a diagram that describes operation of a printing apparatus illustrated in FIG. 1.

FIG. 19 is a graph illustrating a detected amount line representing association relations between upper face positions of a recording medium and received light amounts, according to a first embodiment of the invention.

FIG. 20 is a graph illustrating a detected amount line representing association relations between upper face positions of a recording medium and space distances, according to a first embodiment of the invention.

FIG. 21 is a flowchart illustrating processes performed by a control program of a printing apparatus illustrated in FIG. 1.

FIG. 22 is a flowchart illustrating processes performed by a control program of a printing apparatus illustrated in FIG. 1.

FIG. 23 is an enlarged side view illustrating a printing apparatus according to a second embodiment of the invention.

FIG. 24 is a diagram illustrating operation of a printing apparatus according to a third embodiment of the invention.

FIG. 25 is a diagram illustrating operation of a printing apparatus according to a third embodiment of the invention.

FIG. 26 is a flowchart illustrating processes performed by a control program of a printing apparatus illustrated in FIG. 24.

FIG. 27 is a diagram illustrating a table that indicates association relations between materials forming recording media and correction amounts to be applied in corrections of detected upper face positions of the recording media, according to a third embodiment of the invention.

### DESCRIPTION OF EXEMPLARY EMBODIMENTS

Hereinafter, exemplary embodiments of a printing apparatus and a printing method according to aspects of the invention will be described in detail with reference to the accompanying drawings.

### First Embodiment

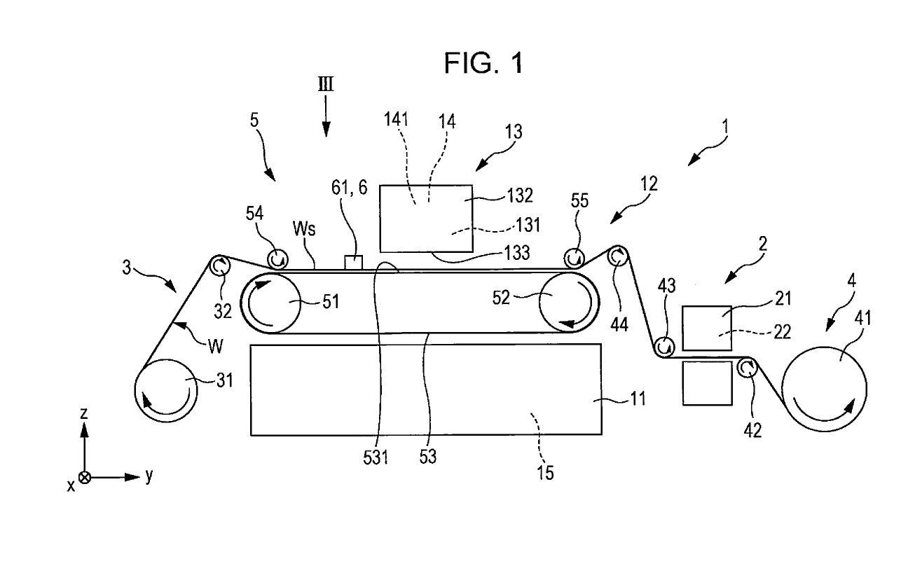

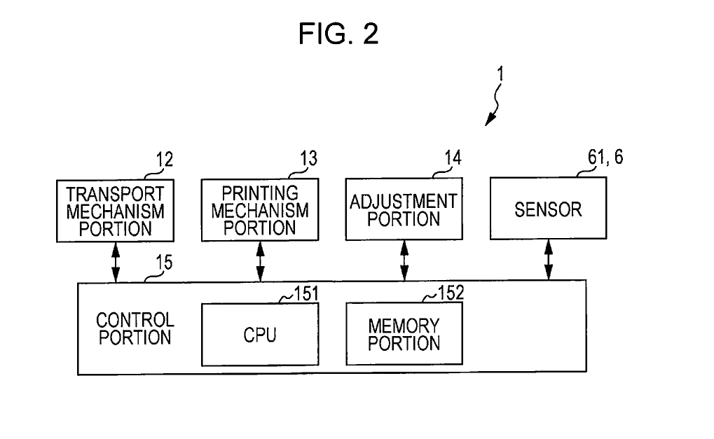

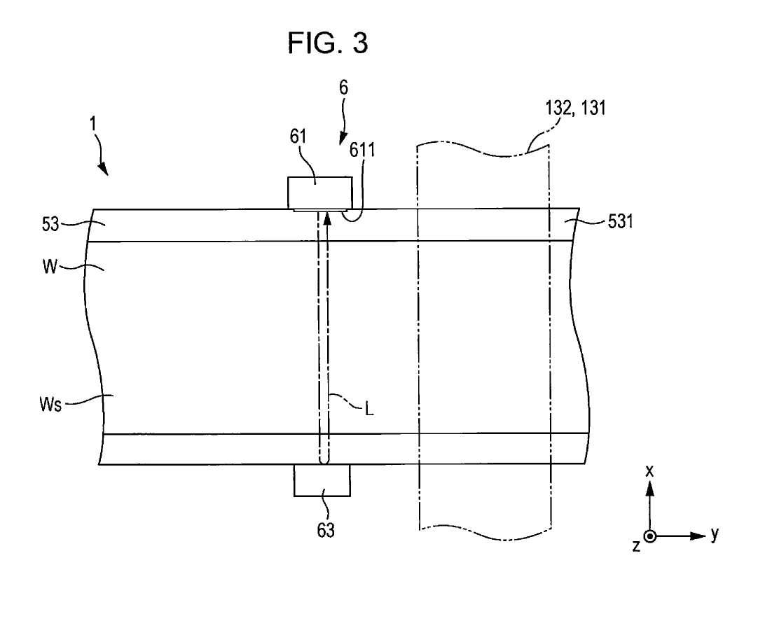

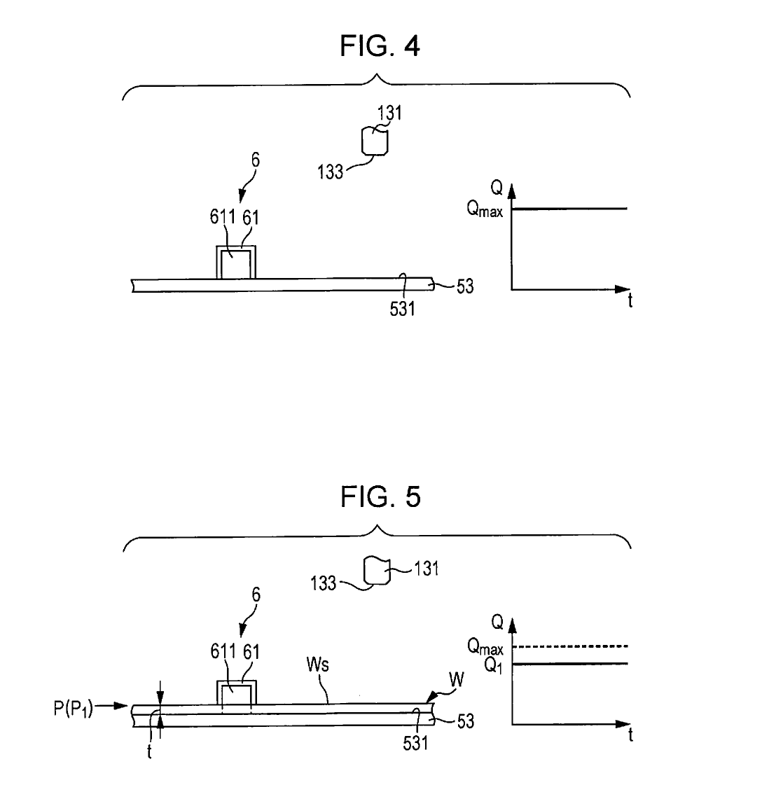

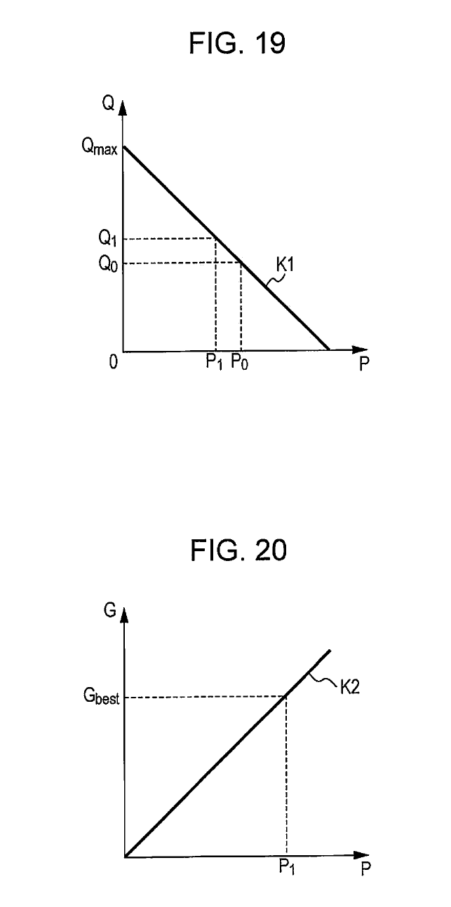

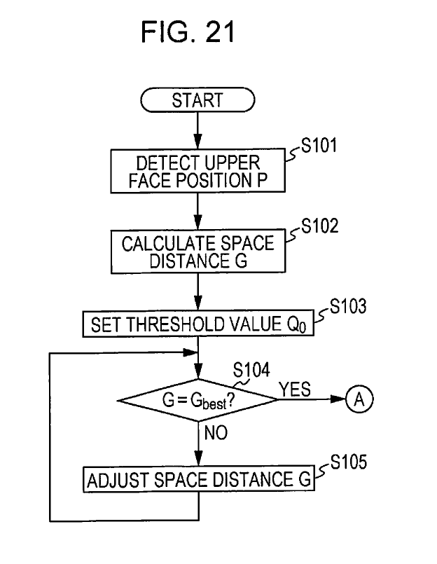

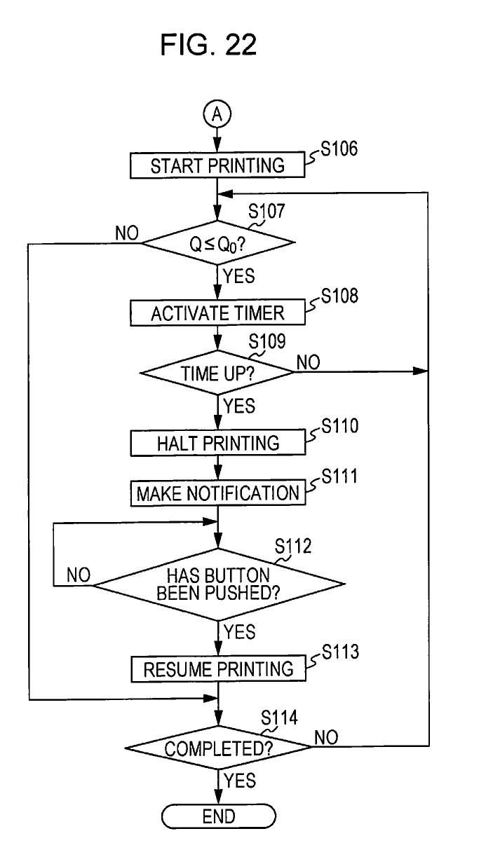

FIG. 1 is a side view schematically illustrating a printing apparatus 1 according to this first embodiment of the invention. FIG. 2 is a block diagram of the printing apparatus 1. FIG. 3 is a diagram illustrating the printing apparatus 1 when the printing apparatus 1 is viewed in a direction indicated by the arrow III of FIG. 1. FIGS. 4 to 18 are diagrams that describe operation of the printing apparatus 1. FIG. 19 is a graph illustrating a detected amount line representing association relations between upper face positions of a recording medium and received light amounts, according to this embodiment. FIG. 20 is a graph illustrating a detected amount line representing association relations between upper face positions of a recording medium and optimal space distances, according to this embodiment. FIGS. 21 and 22 are flowcharts illustrating processes performed by a control program of the printing apparatus 1.

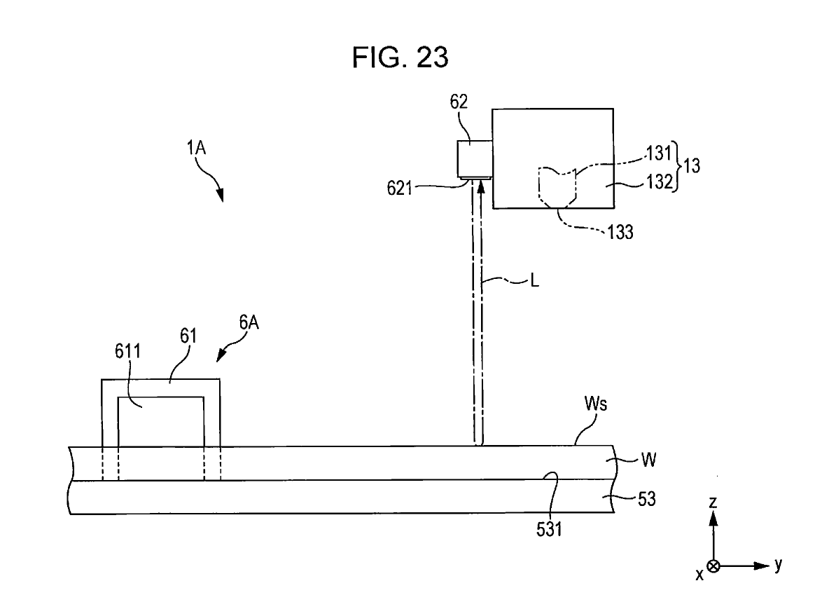

In addition, for convenience of the following description, three mutually perpendicular axes, that is, an x axis, a y axis, and a z axis, are illustrated in FIGS. 1 and 3 (similarly in FIG. 23 of a second embodiment described below). The x axis is an axis indicating a horizontal direction that is one of two horizontal directions and corresponds to a width (depth) direction of the printing apparatus 1; the y axis is an axis indicating a horizontal direction that is the other one of the two horizontal directions and corresponds to a long-side direction of the printing apparatus 1, and that is perpendicular to the x axis; and the z axis is an axis indicating a vertical direction (an upward/downward direction). Further, the leading end side of each of arrows that are illustrated in FIGS. 1, 3, and 23 and that indicate the respective x, y, and z axes indicates “a positive side” in a direction indicated by a corresponding one of the x, y, and z axes; and the base end side of each of the arrows indicates “a negative side” in a direction indicated by a corresponding one of the x, y, and z axes. Further, in description below with reference to each of FIGS. 1, 3, and 4 to 18, a term “upper” or a term “upper side” indicates the upper side of the relevant figure; and a term “lower” or a term “lower side” indicates the lower side of the relevant figure (similarly in FIG. 23 of a second embodiment described below).

As shown in FIGS. 1 and 2, the printing apparatus 1 includes an apparatus base 11; a transport mechanism portion (transport portion) 12 for transporting a work W as a recording medium; a printing mechanism portion (recording portion) 13 for performing printing by ejecting inks 100 onto the work W; a drying portion 2 for drying the inks 100 having landed on the work W; and a detection portion 6.

In this embodiment, a direction perpendicular to a transport direction in which the work W is transported corresponds to a direction indicated by the x axis (i.e., an x-axis direction); a direction parallel to the transport direction corresponds to a direction indicated by the y axis (i.e., a y-axis direction); and a direction perpendicular to each of the x-axis direction and the y-axis direction corresponds to a direction indicated by the z axis (i.e., a z-axis direction).

The transport mechanism portion 12 includes an unwinding apparatus 3 that unwinds the work W having a long length and being in a state of being wound in a roll shape; a winding apparatus 4 that winds the work W having been subjected to printing; and a supporting apparatus 5 that is disposed on the apparatus base 11 and that supports the work W being in a state of being printed.

The unwinding apparatus 3 is disposed at a more upstream position than the apparatus base 11 in a direction in which the work W is transported (i.e., in the y-axis direction). The unwinding apparatus 3 includes a feeding roller (unwinding reel) 31 for feeding the work W, which is wound in a roll shape; and a tensioner 32 for applying a tension to the work W midway between the feeding roller 31 and the supporting apparatus 5. The feeding roller 31 is connected to a motor (not illustrated) and is capable of rotating by being driven by the motor.

In addition, any one of two material types can be used as the work W: a first material type thereof being a thin-film shaped material type that has ink absorbency; a second material type thereof being a thin-film shaped material type that does not have ink absorbency. Examples of materials of the first material type include normal paper; high-quality paper; exclusive paper for ink jet recording, such as glossy paper; and a textile. Examples of materials of the second material type include a plastic film on which any surface treatment for ink jet printing is not performed (that is, any ink absorbing layer is not formed); a material resulting from coating plastic on a base material, such as paper; and a material resulting from bonding a plastic film onto a base material. The plastic is not limited to any particular type of plastic, and examples of the plastic include polyvinylchloride, polyethylene terephthalate, polycarbonate, polystyrene, polyurethane, polyethylene, and polypropylene.

The winding apparatus 4 is disposed at a more downstream position than the apparatus base 11 in the direction in which the work W is transported (i.e., in the y-axis direction) relative to the unwinding apparatus 3. The winding apparatus 4 includes a winding roller (winding reel) 41 for winding the work W such that the work W forms a roll shape, and tensioners 42, 43, and 44 each for applying a tension midway between the winding roller 41 and the supporting apparatus 5. The winding roller 41 is connected to a motor (not illustrated), and is capable of rotating by being driven by the motor. The tensioners 42, 43, and 44 are disposed at intervals in this order in a direction toward the opposite side of the winding roller 41.

The supporting apparatus 5 is disposed midway between the unwinding apparatus 3 and the winding apparatus 4. The supporting apparatus 5 includes a driving roller 51 and a driven roller 52 that are disposed so as to be distanced from each other in the y-axis direction; an endless belt 53 which is provided in a hanging manner between the driving roller 51 and the driven roller 52, and the upper face (the supporting face) of which supports the work W; and tensioners 54 and 55 that apply tensions to the work W midway between the driving roller 51 and the driven roller 52.

The driving roller 51 is connected to a motor (not illustrated), and is capable of rotating by being driven by the motor. Further, the driven roller 52 is capable of rotating in conjunction with the driving roller 51 by being driven by a rotation force that is obtained by transmission of the rotation force of the driving roller 51 via the endless belt 53.

The endless belt 53 is a belt whose obverse face is formed of an adhesion layer having an adherence property. The work W is transported in the y-axis direction in a state in which part of the work W is adhered and fixed to the adhesion layer. Further, during this transport, printing is performed onto the work W. Further, after the completion of the printing, the work W is peeled off from the endless belt 53.

The tensioners 54 and 55 are also disposed so as to be distanced from each other in the y-axis direction, just like the driving roller 51 and the driven roller 52.

The tensioner 54 is capable of pinching the work W together with the endless belt 53 between the driving roller 51 and the tensioner 54 itself, and the tensioner 55 is capable of pinching the work W together with the endless belt 53 between the driven roller 52 and the tensioner 55 itself. Through these mechanisms, the work W is subjected to a tension applied by each of the tensioners 54 and 55, and is transported in a state of being continuously subjected to the tension and thereby being continuously fixed to the endless belt 53. Further, such mechanisms reduce the occurrences of, for example, a wrinkle on the work W during a transport operation, and thus make it possible to, when printing is performed onto the work W, make the result of the printing an accurate and high-quality result.

The printing mechanism portion 13 includes a carriage unit 132 provided with a set of a plurality of ink jet heads 131 that eject the inks 100 onto the work W and thereby perform recording by means of printing; and an X axis table (not illustrated) that supports the carriage unit 132 such that the carriage unit 132 is movable in the x-axis direction. Each of the ink jet heads 131 includes, for example, a head body provided therein with a head inside flow path that is filled with a corresponding one of the inks 100; and a nozzle plate provided with a nozzle face on which the openings of a plurality of ejection nozzles are provided. In the head body, there are provided piezoelectric elements each associated with a corresponding one of the plurality of ejection nozzles, and when a voltage is applied to one of the piezoelectric elements, a corresponding ink 100 is ejected in the form of a liquid droplet through a corresponding ejection nozzle.

In addition, when not in a state of ejecting the inks 100, the set of ink jet heads 131 is placed in a standby state at a position (a standby position) that is distanced from the work W (the endless belt 53) when viewed in the z-axis direction.

The printing apparatus 1 performs intermittent transport (sub-scanning) of the work W, which has been unwounded by the unwinding apparatus 3, in the y-axis direction in a fixed state in which the work W is adhered and fixed to the endless belt 53. Further, in conjunction with the intermittent transport of the work W, the printing apparatus 1 causes the inks 100 to be ejected from the set of ink jet heads 131 while causing the carriage unit 132 to perform reciprocation (main-scanning) in the x-axis direction. The printing apparatus 1 repeats this operation until printing is completed and an image pattern is formed on the work W. In addition, the image pattern may be any one of an image pattern resulting from multi-color printing (color printing), and an image pattern resulting from single-color printing.

As examples of the inks 100, there exist color inks each containing a dye or a pigment as a coloring agent in water as a solvent, and examples of such color inks include four color inks whose colors are cyan (C), magenta (M), yellow (Y), and black (B). Further, each of color inks as the inks 100 is independently ejected from a corresponding one of the ink jet heads 131.

An adjustment portion 14 shown in FIGS. 1 and 2 is a rising/falling mechanism capable of adjusting the height of the set of the ink jet heads 131. The adjustment portion 14 can be constituted by using, for example, a motor, ball screws, and a linear guide. Further, an encoder 141 is incorporated in the motor. The height of the set of ink jet heads 131 can be detected on the basis of a rotation amount detected by the encoder 141. The adjustment portion 14 configured in such a way as described above is also electrically connected to the control portion 15.

As shown in FIG. 1, the drying portion 2 is disposed at a position that is a more downstream position than the printing mechanism portion 13 in the transport direction in which the work W is transported, and that is located midway between the supporting apparatus 5 and the winding apparatus 4.

The drying portion 2 includes a chamber 21 and a coil 22 that is disposed inside the chamber 21. The coil 22 is constituted by, for example, a nichrome wire, and is a heating element that produces heat by being supplied with electric power. Further, the heat produced by the coil 22 makes it possible to dry the inks 100 having landed on the work W that is in a state of passing through the inside of the chamber 21.

As shown in FIGS. 1, and 3 to 18, the detection portion 6 is disposed at a position that is a more upstream position than the printing mechanism portion 13 in the transport direction in which the work W is transported, and that is located midway between the printing mechanism portion 13 and the tensioner 54. The detection portion 6 is a component for detecting an upper face position P of the work W that is in a state of passing through the detection portion 6 itself. Further, when a prominent portion resulting from a prominence of an upper face Ws of the work W arises, the detection portion 6 is capable of detecting such a prominent portion.

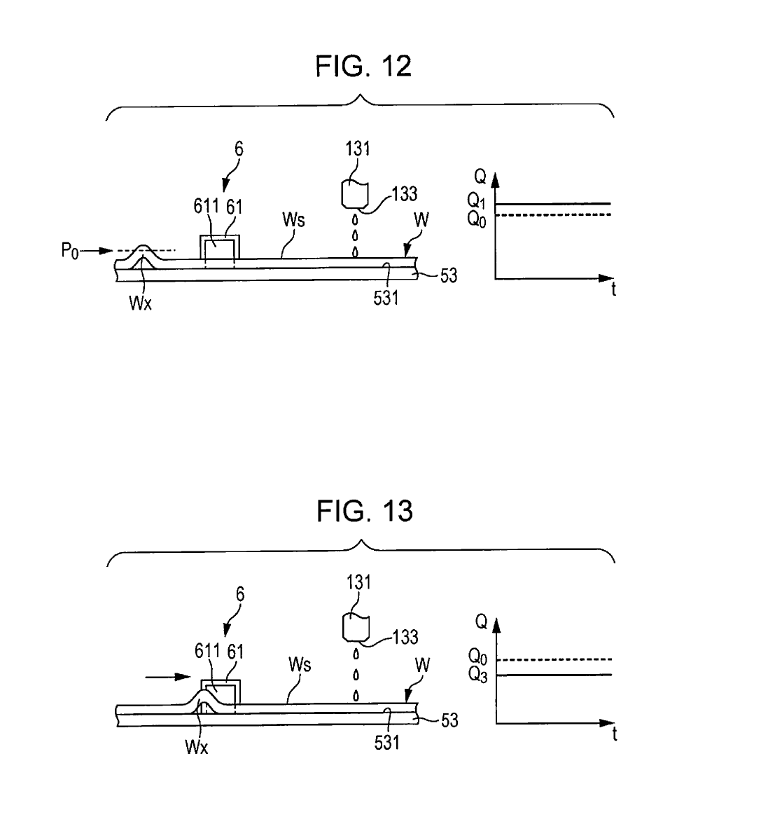

In addition, the prominent portion encompasses a wrinkle, a curling portion, a seam, and the like. The ejections of the inks 100 onto such a prominent portion sometimes cause a failure in normal printing onto the prominent portion, and when the degree of the prominence of the prominent portion is large, the prominent portion is likely to come into collision with the set of ink jet heads 131. In addition, in the following description, a case where “the prominent portion” is “a wrinkle Wx” shown in FIGS. 12 to 15 will be described as an example.

As shown in FIG. 3, the detection portion 6 includes a sensor 61 and a reflection portion 63. The sensor 61 and the reflection portion 63 are disposed so as to face each other across the width of the endless belt 53.

The sensor 61 is disposed at one of the width-direction sides of the endless belt 53 (i.e., at the upper side in FIG. 3). The sensor 61 is a reflection type photo-sensor including a detection face (light reception area) 611 that emits/receives light. The detection face 611 forms a square shape, and faces the negative side in the x-axis direction. The length of each of the sides of the detection face 611 is not particularly limited, but is, for example, anywhere from five to twenty millimeters. In the detection face 611, an area from the lower side up to the upper side thereof is a detection area.

Further, the lower side of the detection face 611 and the upper face 531 of the endless belt 53 are located so as to overlap with each other. That is, no space is formed between the lower side of the detection face 611 and the upper face of the endless belt 53 when viewed in the x-axis direction. Through this configuration, the work W on the endless belt 53 results in overlapping with the detection face 611 with certainty. Thus, no matter how thin the work W is, the sensor 61 is capable of detecting any wrinkle on the work W.

The sensor 61 configured in this way is electrically connected to the control portion 15, which controls operation of the sensor 61.

As shown in FIG. 3, the reflection portion 63 is disposed at the other one of the width-direction sides of the endless belt 53 (i.e., at the lower side in FIG. 3). The reflection portion 63 reflects light L that is emitted from the sensor 61.

The light L having been emitted from the detection face 611 is reflected at the reflection portion 63, and enters the detection face 611. The printing apparatus 1 is configured such that a signal including a piece of information indicating a received light amount Q of light that is received at the detection face 611 is transmitted to the control portion 15. Further, the printing apparatus 1 is configured to be able to detect the upper face position P on the basis of the variation of the received light amount Q.

As shown in FIG. 2, the control portion (determination portion) 15 is electrically connected to the transport mechanism portion 12, the printing mechanism portion 13, the adjustment portion 14, and the detection potion 6, and has the function of controlling the operations of these individual portions. Further, the control portion 15 includes a central processing unit (CPU) 151 and a memory portion 152.

The CPU 151 executes programs for various processes, such as the printing process described above.

The memory portion 152 includes, for example, an electrically erasable programmable read-only memory (EEPROM) device that is one of various types of non-volatile semiconductor memory devices, and is capable of storing the programs and the like in the EEPROM device.

Meanwhile, heretofore, a conventional method, in which a reference position P₀, which is a determination reference value that specifies at what degree of height a prominent portion on the work W is to be deemed as a wrinkle Wx, is manually input by an operator in accordance with a thickness t (the upper face position P) of the work W, has been employed. Hereinafter, this conventional method will be described by providing a first case where a work W whose thickness t is “ten millimeters” is used, and a second case where a work W whose thickness t is “twenty millimeters” is used.

First, the first case where the work W whose thickness t is ten millimeters is used will be described. In this case, an operator determines in advance that any portion which exists on the work W, and the upper face position P of which is distanced from the upper face 531 of the endless belt 53 by a distance larger than, for example, a value “eleven millimeters” is to be deemed as the wrinkle Wx. Further, in this case, the operator performs an input operation of inputting a piece of information indicating the value “eleven millimeters” into the printing apparatus 1.

Next, the second case where the work W whose thickness t is twenty millimeters is used will be described. In this case, an operator determines in advance that any portion which exists on the work W, and the upper face position P of which is distanced from the upper face 531 of the endless belt 53 by a distance larger than, for example, a value “twenty-two millimeters” is to be deemed as the wrinkle Wx. Further, in this case, the operator performs an operation of inputting a piece of information indicating the value “twenty-two millimeters” into the printing apparatus 1.

The above input operations are manually performed by an operator, and thus, there is a possibility that the operator makes a mistake described below. For example, in the case where the work W having a thickness of ten millimeters is used, there is a possibility that the operator inputs the piece of information indicating “twenty-two millimeters” although required to input the piece of information indicating “eleven millimeters”. In this case, even though a wrinkle Wx occurs and its upper face position P rises up to a position that is distanced from the upper face 531 of the endless belt 53 by a distance of, for example, eighteen millimeters, the distance of eighteen millimeters is not larger than the input value “twenty-two millimeters”, and thus, the occurred wrinkle Wx is not deemed as the wrinkle Wx. If printing is continued in a state in which such an incorrect setting remains, a situation where the printing is performed onto the wrinkle Wx is likely to occur, and/or a situation where the wrinkle Wx comes into collision with the set of ink jet heads 131 is likely to occur.

According to this embodiment, the printing apparatus 1 is configured to be effective in certainly preventing the occurrence of such failure situations. Hereinafter, the operation (the usage method) of the printing apparatus 1 will be described.

First, an operator activates the printing apparatus 1 by operating, for example, a touch panel or the like. In this state, as shown in FIG. 4, the work W is not yet placed on the endless belt 53. In the state shown in FIG. 4, the entire portion of the detection face 611, this entire portion being denoted by hatching in FIG. 4, receives light having been reflected at the reflection portion 63, and a received light amount Q of the reflected light reaches a maximum received light amount Qₘₐₓ.

Next, as shown in FIG. 5, the operator places the work W on the upper face 531 of the endless belt 53. At this time, the operator visually confirms that the work W is placed in a state of being straightly stretched. Here, the state of being straightly stretched means a state in which any prominence including the wrinkle Wx and the like does not exist on the upper face 531 of the endless belt 53. In this state, the work W blocks the reflected light from entering the detection face 611. Thus, the area of a portion constituting the detection face 611 and receiving the reflected light is reduced and, as a result, becomes smaller than that in the state shown in FIG. 4 (refer to a portion denoted by hatching in FIG. 5). Thus, in this state, the received light amount Q becomes a received light amount Q₁ that is smaller than the maximum received light amount Qₘₐₓ. Incidentally, the printing apparatus 1 is configured to be able to obtain an upper face position P₁ corresponding to the received light amount Q₁ on the basis of a detected amount line K1, shown in FIG. 19, which represents association relations between the received light amounts Q and the upper face positions P. The detected amount line K1 is stored in the memory portion 152 in advance in the form of a calculation formula or a table. Similarly, a detected amount line K2, which will be described below in detail, is also stored in the memory portion 152 in advance in the form of a calculation formula or a table.

In addition, in the state shown in FIG. 5, in which the work W is placed in the state of being straightly stretched, the upper face position P corresponds to a position that is distanced from the upper face 531 of the endless belt 53 by a distance equal to the thickness t of the work W.

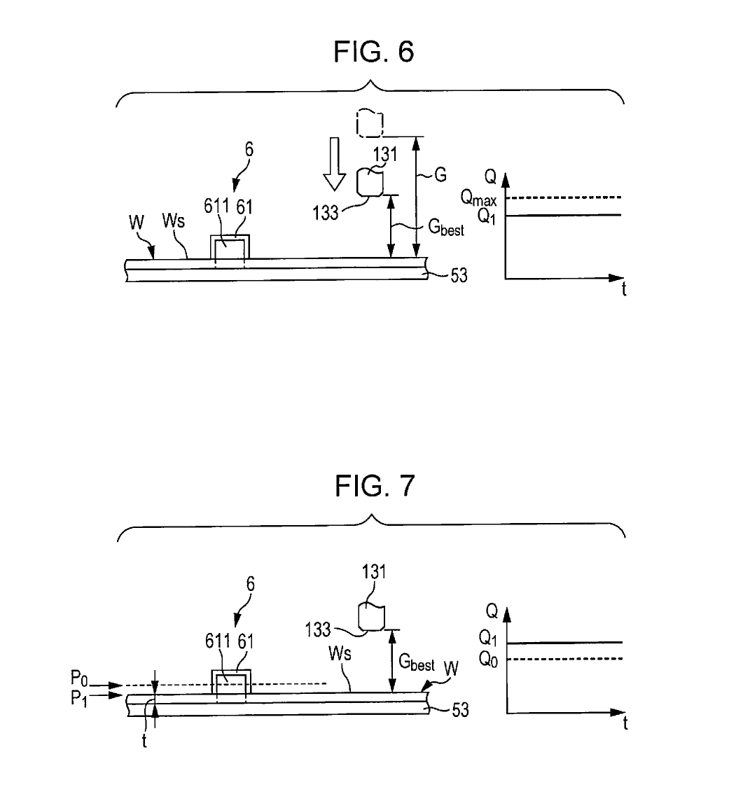

Next, as shown in FIG. 6, the operator operates the adjustment portion 14 in order to adjust a space distance G (i.e., the distance of a space) between the upper face Ws of the work W and a lower face 133 of the set of ink jet heads 131 so as to make the space distance G be equal to an optimal space distance G_{best}. This optimal space distance G_{best} is a space distance that makes it possible to obtain a crisp printing result. In this way, it is possible to start printing with certainty in such a state in which the space distance G is set to the optimal space distance G_{best}.

The operator may adjust the space distance G while directly measuring the space distance G by using an independently prepared measurement tool, but the printing apparatus 1 is provided with a scale that displays thereon a distance PG between the lower face 133 of the set of ink jet heads 131 and the upper face 531 of the endless belt 53. Thus, the operator is able to, without using the independently prepared measurement tool, adjust the space distance G into the optimal space distance G_{best} merely by using the displayed distance PG, and the thickness t of the work W, having been confirmed above, and making a value resulting from subtracting the thickness t from the distance PG be equal to the optimal space distance G_{best}.

In addition, the printing apparatus 1 is configured to obtain the optimal space distance G_{best} on the basis of the detected amount line K2, shown in FIG. 20, which represents association relations between the upper face positions P of the work W and the best distances G_{best}, but it is also possible to configure the printing apparatus 1 such that the printing apparatus 1 is capable of determining the optimal space distance G_{best} on the basis of optionally selected conditions, such as a state of the surface of the work W.

Subsequently, in the printing apparatus 1, the reference position P₀ is set (refer to a graph shown FIG. 7). The reference position P₀ is a determination reference value that specifies at what degree of height a prominent portion on the work W is to be deemed as the wrinkle Wx. The reference position P₀ is set on the basis of the upper face position P₁ of the work W and the space distance G_{best}, which have been obtained above. Further, the reference position P₀ is set so as to be located at a height between the upper face Ws of the work W and the set of ink jet heads 131.

Further, when the reference position P₀ has been set, a threshold value Q₀ is set on the basis of the detected amount line K1.

In this way, the reference position P₀, which has been manually input by an operator in a conventional method, is automatically set in this embodiment according to the invention, and thus, the input operation by an operator can be skipped. Thus, it is possible to certainly prevent any occurrence of a mistake in the operator's input operation. Accordingly, it is possible to detect the wrinkle Wx accurately and certainly. As a result, it is possible to certainly prevent the occurrence of failure situations, such as a failure situation where printing is performed onto a prominent portion that is deemed as the wrinkle Wx, and a failure situation where such a prominent portion that is deemed as the wrinkle Wx comes into collision with the set of ink jet heads 131.

In addition to the above-described automatic setting of the reference position P₀, when the reference position P₀, which is manually set by an operator, is incorrect, the printing apparatus 1 is capable of detecting the incorrect setting.

In addition, the printing apparatus 1 is configured to be able to detect the upper face position P (the thickness t) of the work W, and thus, any operator's operation of inputting a value of the thickness t is not required. In this way, once the work W is placed on the endless belt 53, the settings required to be performed before the start of printing are automatically performed, and thus, it is possible to easily start the printing.

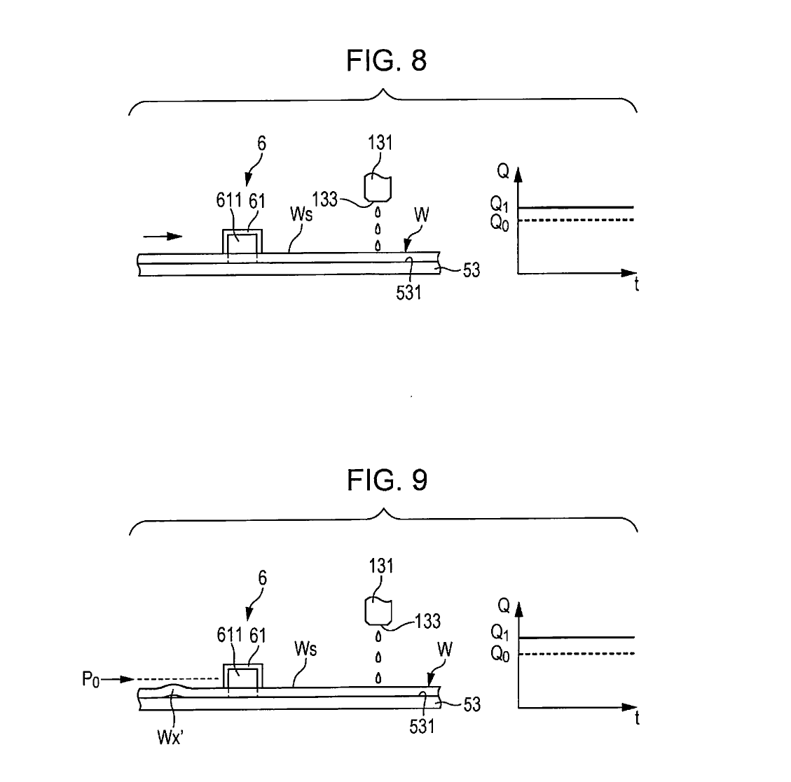

When the threshold value Q₀ has been set in such a way described above, printing is started as shown in FIG. 8.

FIG. 8 is a diagram illustrating a state in which printing is performed by the printing apparatus 1. In this state, any wrinkle Wx does not yet occur on the work W, and the work W is transported in a state of being straightly spread on the endless belt 53. Further, the ink jet heads 131 are in a state of ejecting the inks 100.

At this time, the detection face 611 is in a state in which a portion that constitutes the detection face 611 and that is denoted by hatching in FIG. 8 receives the reflected light, and the received light amount Q remains to be equal to the received light amount Q₁.

When, as shown in FIG. 9, a wrinkle Wx′ has occurred at a more upstream position than the sensor 61 in the transport direction, the wrinkle Wx′ moves toward the downstream side. An upper face position P of this wrinkle Wx′ is located at a height lower than the height of the reference position P₀.

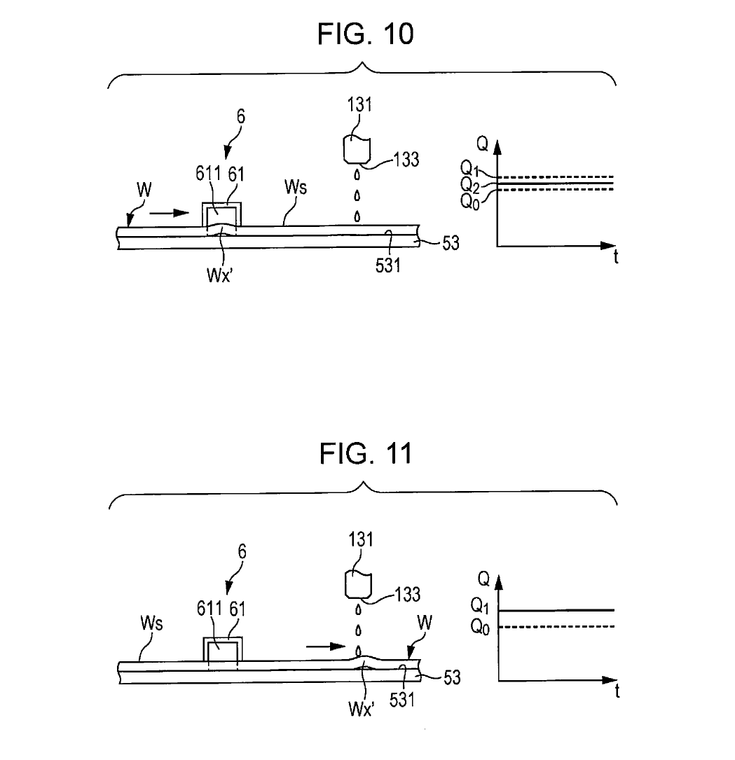

Further, as shown in FIG. 10, the wrinkle Wx′ moves to a position overlapping with the detection face 611. At this time, the received light amount Q becomes smaller than the received light amount Q₁ by a light amount having been blocked by the wrinkle Wx′, but becomes a received light amount Q₂ larger than the threshold value Q₀. Since the received light amount Q₂ is not smaller than or equal to the threshold value Q₀, it is determined that there is no problem even when the wrinkle Wx′ is further transported toward the downstream side and, as a result, the printing is continued, as shown in FIG. 11.

Further, when, as shown in FIG. 12, a wrinkle Wx has occurred at a more upstream position than the sensor 61, the wrinkle Wx moves toward the downstream side. An upper face position P of this wrinkle Wx is located at a height higher than the height of the reference position P₀.

Further, as shown in FIG. 13, the wrinkle Wx″ moves to a position overlapping with the detection face 611. At this time, the wrinkle Wx blocks the reflected light from entering the entire portion of the detection face 611 and, as a result, the received light amount Q becomes a received amount Q₃ that is smaller than the threshold value Q₀.

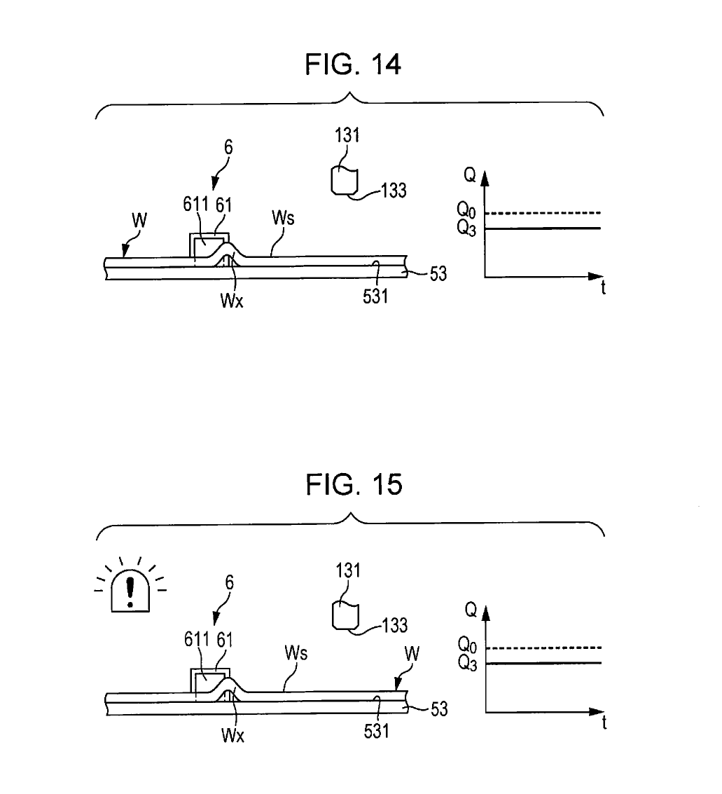

Further, as shown in FIG. 14, the wrinkle Wx moves further toward the downstream side in a state of blocking the reflected light from entering the entire portion of the detection face 611. Thus, the state in which the received light amount Q is equal to the light amount Q₃ is continued. Further, upon detection of the continuance of the above state, the control portion 15 determines that the wrinkle Wx is still occurred.

Further, as shown in FIG. 14, upon determination of the occurrence of the wrinkle Wx, the control portion 15 halts the transport of the work W and the ejections of the inks 100. Further, as shown in FIG. 15, the printing apparatus 1 notifies the operator of the detection of the wrinkle Wx. In addition, the method for notifying the detection of the wrinkle Wx is not particularly limited, but may be a method of lighting a lamp, as shown in FIG. 15, or may be a method of sounding an audible alarm.

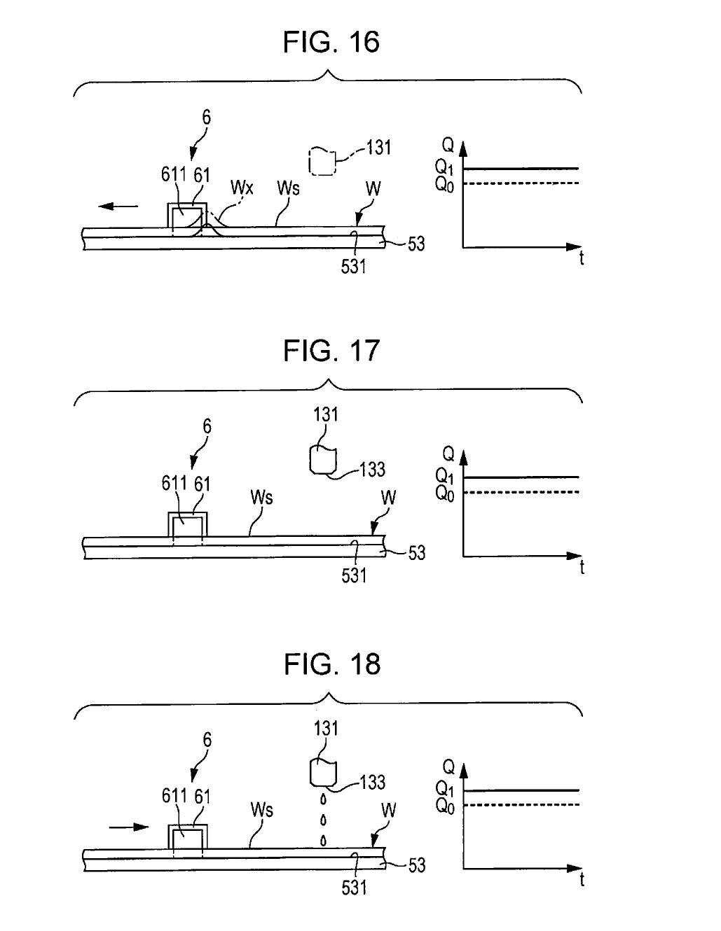

In addition, the printing apparatus 1 is configured such that, as shown in FIG. 16, when the printing has been halted, the set of ink jet heads 131 is moved to the standby position.

Further, the operator removes the wrinkle Wx by stretching/straining the work W in a direction indicated by the arrow shown in FIG. 16. When having removed the wrinkle Wx, as shown in FIG. 17, the operator pushes a printing resumption button that is displayed on, for example, a touch panel. Through this operation, printing is resumed.

Further, in this case, the set of ink jet heads 131 is located at the standby position, and thus, it is possible to prevent the operator's operation for removing the wrinkle Wx from being blocked by the set of ink jet heads 131.

The printing apparatus 1 is configured to, through such operations described above, detect a wrinkle Wx on the work W that is in a state of being transported, and thereby be able to prevent the occurrence of a failure situation where printing is performed onto the wrinkle Ws and/or a failure situation where the wrinkle Wx comes into collision with the set of inkjet heads 131.

Such processing for detecting the wrinkle Wx and thereby preventing execution of printing onto the wrinkle Wx, as described above, is stored as a control program in advance in the memory portion 152 of the control portion 15. Hereinafter, processes that are performed by the control portion 15 on the basis of this control program will be described on the basis of a flowchart shown in FIGS. 21 and 22.

First, an operator places a work W on the endless belt 53 prior to starting of printing (refer to FIG. 5). Subsequently thereto, the control portion 15 detects an upper face position P (a thickness t) of the work W (step S101). Further, the control portion 15 calculates a space distance G between the upper face position P of the work W and the set of ink jet heads 131. The control portion 15 calculates this space distance G on the basis of an encoded value that is output from the encoder 141 of the adjustment portion 14 and the upper face position P having been detected in step S101.

In step S103, the control portion 15 sets a threshold value Q₀. The control portion 15 sets this threshold value Q₀ on the basis of the upper face position P having been obtained in step S101 and an optimal space distance G_{best} that is stored so as to be associated with the obtained upper face position P.

Further, in step S104, the control portion 15 determines whether or not the space distance G having been obtained in step S102 is equal to the optimal space distance G_{best}. When having determined that the space distance G is equal to the optimal space distance G_{best}, the control portion 15 causes the process flow to proceed to step S106. When having determined that the space distance G is not equal to the optimal space distance G_{best}, the control portion 15 prompts the operator to activate the adjustment portion 14 and thereby adjust the height of the set of ink jet heads 131 as shown in FIG. 6 (step S105), and then causes the process flow to return to step S104.

Through the above processes in steps S101 to S105, the space distance G is made equal to the optimal space distance G_{best}.

Subsequently, the control portion 15 starts printing by activating the transport mechanism portion 12 and the printing mechanism portion 13 and, simultaneously therewith, starts detection of the wrinkle Wx by activating the sensor 61 (step S106).

The control portion 15 determines whether or not a received light amount Q having been detected by the sensor 61 is smaller than or equal to the threshold value Q₀ having been obtained in step S103 (step S107). When having determined, in step S107, that the received light amount Q is not smaller than or equal to the threshold value Q₀, as shown in FIG. 10, the control portion 15 executes a process in step S114.

When having determined, in step S107, that the received light amount Q is smaller than or equal to the threshold value Q₀, the control portion 15 activates a timer that is incorporated in the control portion 15 itself (step S108). When having determined, in step S109, that the value of the timer does not yet reach a preset value, the control portion 15 causes the process flow to return to step S107. Further, the control portion 15 executes the processes in step S107 and subsequent steps step-by-step until the control portion 15 determines, in step S109, that the value of the timer has reached the preset value.

When having determined, in step S109, that the value of the timer has reached the preset value, the control portion 15 halts printing, that is, the ejections of the inks 100 and the transport of the work W (step S110). At this time, although the printing is in a state of being executed, the control portion 15 halts the ejections of the inks 100 and moves the set of ink jet heads 131 to the standby position.

Further, the control portion 15 notifies the operator of the detection of the wrinkle Wx to prompt the operator to remove the wrinkle Wx (step S111). Here, after having removed the wrinkle Wx by stretching/straining the work W, the operator pushes a printing resumption button when the operator desires to resume the printing.

When having determined, in step S112, that the printing resumption button has been pushed, the control portion 15 resumes the printing (step S113). At this time, the control portion 15 causes the set of ink jet heads 131 to return to a position where the ejections of the inks 100 has been halted, and resumes the ejections of the inks 100.

Further, in step S114, the control portion 15 determines whether or not the printing has been completed. When having determined that the printing has been completed, the control portion 15 terminates the printing processes. When having determined, in step S114, that the printing is not yet completed, the control portion 15 causes the process flow to return to step S107, and executes the processes in step S107 and subsequent steps step-by-step.

As described above, the printing apparatus 1 is configured to, once a work W is placed on the endless belt 53 by an operator, automatically set the threshold value Q₀, which is a determination reference value in accordance with which it is determined whether or not the transport of the work W is to be allowed. In this way, it is possible to prevent the occurrence of a mistake in the operator's operation of inputting the threshold value Q₀.

Moreover, according to the printing apparatus 1 of this embodiment, it is possible to certainly detect the occurrence of the wrinkle Wx and thereby prevent the occurrence of failure situations, such as a failure situation where printing is executed onto the wrinkle Wx and a failure situation where the wrinkle Wx comes into collision with the set of ink jet heads 131.

### Second Embodiment

FIG. 23 is an enlarged side view illustrating a printing apparatus 1A according to this second embodiment of the invention.

Hereinafter, the printing apparatus 1A according to this second embodiment will be described with reference to FIG. 23. The description will be made centering on points different from those of the aforementioned embodiment, and items similar to those of the aforementioned embodiment will be omitted from the description.

This second embodiment is the same as the aforementioned first embodiment except the configuration of a detection portion.

As shown in FIG. 23, a detection portion 6A of the printing apparatus 1A includes a sensor (a first sensor) 61, and a sensor (a second sensor) 62 that is disposed at the upper side than the endless belt 53.

The sensor 62 is disposed on one of the side faces of the carriage unit 132, the one of the side faces being located at a more upstream position than the set of ink jet heads 131. Moreover, the sensor 62 is disposed at a position overlapping with the endless belt 53 (the work W) when viewed in the z-axis direction.

The sensor 62 is constituted by a reflection type photo-sensor including a detection face 621 that emits/receives light in a thickness direction of the endless belt 53. The light emitted from the detection face 621 is reflected at the upper face of the work W, and reflection light having been reflected at the upper face of the work W enters the detection face 621. The sensor 62 is capable of detecting an upper face position P of the work W on the basis of a variation of a received light amount of the entered reflection light.

According to the printing apparatus 1A configured in this way, the sensor 61 can be used as a sensor dedicated to detection of the wrinkle Wx during a printing operation performed by the printing apparatus 1A, and the sensor 62 can be used as a sensor dedicated to detection of the upper face position P of the work W before staring of the printing operation performed by the printing apparatus 1A. Through the use of such dedicated sensors 61 and 62, it is possible to increase the accuracy in both of the detection operations each performed by a corresponding one of the sensors 61 and 62.

Further, it is also possible to, when detecting the upper face position P before starting of a printing operation, detect a received light amount of the reflected light while moving the sensor 62 above the work W. In this case, it is possible to acquire upper face positions P continuously or at a plurality of points, and thus, it is possible to detect the thickness t of the work W with further accuracy.

Moreover, since each of the sensors 61 and 62 is constituted by a reflection type photo-sensor, it is possible to make the number of required wirings smaller, as compared with a case in which a light emitting portion and a light receiving portion are separately provided. Thus, it is possible to simplify the configuration of the printing apparatus 1A.

### Third Embodiment

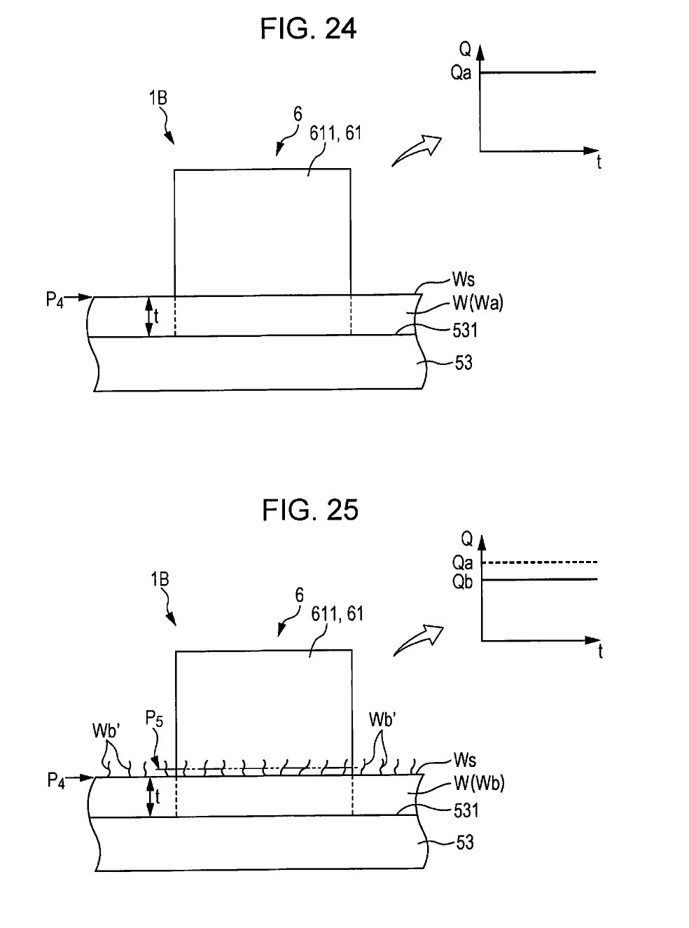

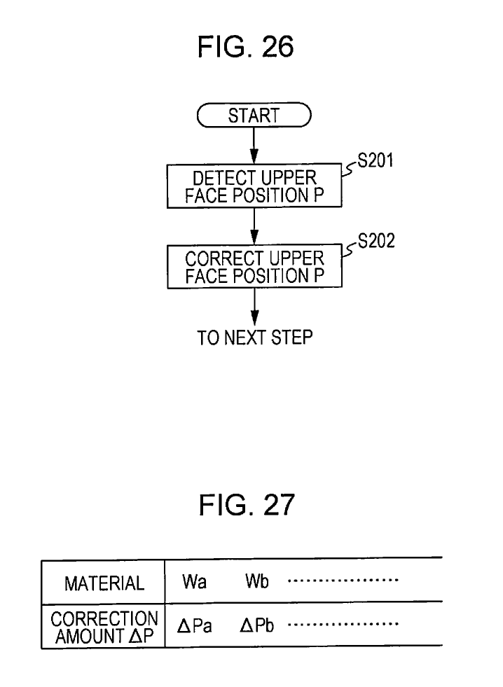

FIGS. 24 and 25 are diagrams each illustrating operation of a printing apparatus 1B according to this third embodiment of the invention. FIG. 26 is a flowchart illustrating processes performed by a control program of the printing apparatus 1B. FIG. 27 is a diagram illustrating a table that indicates association relations between materials forming recording media and correction amounts to be applied in corrections of detected upper face positions of the recording media.

Hereinafter, the printing apparatus 1B according to this third embodiment will be described with reference to FIGS. 24 to 27. The description will be made centering on points different from those of the aforementioned embodiments, and items similar to those of the aforementioned embodiments will be omitted from the description.

This third embodiment is the same as the aforementioned first embodiment except that a control program is different from that of the aforementioned first embodiment.

The printing apparatus 1B shown in FIGS. 24 and 25 is configured to, before detecting an upper face position P of a placed work W before starting of printing, prompt an operator to input a material forming the work W. Further, the printing apparatus 1B is configured to be able to set the upper face position P with accuracy on the basis of the input material forming the work W. Hereinafter, such an accurate setting of the upper face position P of the work W through the input of a material forming the work W will be described by way of an example using two kinds of works which have the same thickness t and each of which is formed of a corresponding one of mutually different materials Wa and Wb.

The material Wa is a material, such as paper, the surface of which is relatively smooth. As shown in FIG. 24, when a work W formed of the material Wa is placed on the endless belt 53, the upper face position P of the work W corresponds to an upper face position P₄, and the received light amount Q with respect to the work W is equal to a received light amount Qa.

Meanwhile, the material Wb is a material, such as a textile, which has a nap Wb′ on the surface thereof. As shown in FIG. 25, when a work W formed of the material Wb is placed on the endless belt 53, although an actual upper face position P, which is a position of a face onto which printing is performed, corresponds to the upper face position P₄, the received light amount Q with respect to the work W becomes equal to a received light amount Qb that is smaller than the received light amount Qa with respect to the work W formed of the material Wa. This is because the received light amount Q is reduced by an amount of light blocked by the nap Wb′. Thus, as represented by a chain double-dashed line in FIG. 25, the upper face position P of the work W formed of the material Wb is detected once as an upper face position P₅, which is located higher than the upper face position P₄, but the upper face position P₅ can be corrected in this embodiment. Hereinafter, processes that are performed by the control portion 15 on the basis of a control program stored therein will be described on the basis of a flowchart shown in FIG. 26.

First, an operator places a work W on the endless belt 53, and selects a material forming the work W by operating, for example, a touch panel. Here, it is assumed that the operator selects the material Wb as a material forming the placed work W.

In step S201, the control portion 15 detects the upper face position P of the work W formed of the material Wb. At this time, the received light amount Q having been detected on the detection face 611 is equal to the received light amount Qb. Thus, although the actual upper face position P corresponds to the upper face position P₄ the control portion 15 detects the upper face position P₅ as the upper face position P of the work W formed of the material Wb.

Subsequently, in step S202, the control portion 15 corrects the upper face position having been detected as the upper face position P of the work W. In step S202, the control portion 15 obtains a correction amount ΔP on the basis of a table shown in FIG. 27, in which materials forming works W are each associated with a corresponding one of correction amounts ΔP. In this case, since a correction amount ΔPb is obtained as a correction amount ΔP corresponding to the material Wb, the upper face position P₄ can be obtained as the actual upper face position P by performing a calculation using a correction expression: (P₅−ΔPb).

As described above, although the upper face position P₅ has been detected once, the upper face position P₅ can be corrected into the upper face position P₄ that is the actual upper face position P.

In addition, it is assumed that an operator places a work W on the endless belt 53, and selects the material Wa as a material forming the placed work W. In this case, the actual upper face position P of the work W formed of the material Wa corresponds to the upper face position P₄ that has been actually detected. Accordingly, a correction amount ΔPa shown in FIG. 27 is actually equal to zero, and thus, no correction is actually made.

Subsequently, the control portion 15 performs the process in step S102 of the flowchart shown in FIG. 22, and then performs the processes in subsequent steps step-by-step just like in the first embodiment.

As described above, according to this third embodiment, it is possible to certainly detect the upper face position P of a work W in a manner that does not depend on any material forming the work W. As a result, it is possible to set the space distance G and the threshold value Q₀ with further accuracy.

Hereinbefore, some embodiments of a printing apparatus and a printing method according to aspects of the invention have been described referring to the accompanying drawings, but the invention is not limited to the above-described embodiments. Each of the constituent portions of the above-described embodiments of a printing apparatus according to aspects of the invention can be replaced by, or can be subjected to addition of, any constituent portion capable of exerting functions similar to the functions of the relevant constituent portion.

Further, any embodiment obtained by combining any two or more ones of the constituent portions (features) of the above-described embodiments may be made an embodiment of a printing apparatus according to aspects of the invention.

In the above-described embodiments one or two sensors are provided, but the invention is not limited to this configuration. Three or more sensors may be provided.

Further, in the above-described embodiments, the detection face forms a square shape, but the invention is not limited to this configuration. The detection face may form any one of shapes, such as a circular shape, an elliptical shape, a triangular shape, and a polygonal shape.

Further, in the above-described embodiments, the adjustment of the space distance between the recording medium and the set of ink jet heads is performed by bringing up and down of the set of ink jet heads, but the invention is not limited to this configuration. The adjustment of the space distance may be performed by bringing up and down of the endless belt.

Further, in the above-described embodiments, there has been described a case where a portion, which exists on a recording medium and the upper face position of which has become high due to the occurrence of a wrinkle or the like on the recording medium, is detected, but the invention is not limited to such a case. It is also possible to detect any portion which exists on a recording medium and the thickness of which is small, because such a portion increases a received light amount detected on the detection face.

In the case where the upper face position of a recording medium becomes lower than a predetermined range, ink jet heads do not come into collision with the recording medium, but variations occur in ink landing positions between outward printing and homeward printing, thereby causing a problem in that a difficulty arises in realization of printing with an intended image quality.

Accordingly, according to an aspect of the invention, it is possible to realize, for example, a method that allows transport of a recording medium when the upper face of the recording medium is within a predetermined range, and that inhibits the transport of the recording medium when the upper face of the recording medium is out of the predetermined range.

The entire disclosure of Japanese Patent Application No. 2014-227460, filed Nov. 7, 2015 is expressly incorporated by reference herein.

What is claimed is:

1. A printing apparatus comprising:
a transport portion that transports a recording medium of a sheet shape;
a printing portion that is disposed so as to face, across a space, the recording medium being in a state of being transported by the transport portion and that includes a plurality of nozzles through which inks are ejected and thereby printing is performed onto the recording medium; and
a determination portion that determines whether or not the transport of the recording medium is to be allowed, on the basis of an upper face position of the recording medium and a distance of the space.

2. The printing apparatus according to claim 1, further comprising a detection portion that is disposed at a more upstream position than the plurality of nozzles in a transport direction in which the recording medium is transported, and that detects the upper face position.

3. The printing apparatus according to claim 2, wherein the transport of the recording medium is allowed when the upper face position having been detected by the detection portion is within a predetermined range, and the transport of the recording medium is inhibited when the upper face position having been detected by the detection portion is out of the predetermined range.

4. The printing apparatus according to claim 2,
wherein the recording medium forms a belt shape and is transported in a direction along a long side of the recording medium, and
wherein the detection portion is constituted by a sensor that detects a received light amount of light entering in a direction along a width of the recording medium.

5. The printing apparatus according to claim 2,
wherein the recording medium forms a belt shape and is transported in a direction along a long side of the recording medium, and
wherein the detection portion is constituted by a first sensor that detects a received light amount of reflection light having been reflected at the recording medium, and a second sensor that detects a received light amount of light entering in a direction along a width of the recording medium.

6. The printing apparatus according to claim 5, wherein the first sensor is a sensor that detects the upper face position before starting of a recording operation performed by the printing apparatus, and the second sensor is a sensor that detects the upper face position during the printing operation performed by the printing apparatus.

7. The printing apparatus according to claim 5, wherein each of the first sensor and the second sensor is a reflection type sensor.

8. The printing apparatus according to claim 1 further comprising an adjustment portion for adjusting a height of the plurality of nozzles.

9. The printing apparatus according to claim 1, wherein the control portion corrects the upper face position of the recording medium on the basis a material of the recording medium.

10. A printing method for use in printing using a transport portion that transports a recording medium of a sheet shape, and a printing portion that is disposed so as to face, across a space, the recording medium being in a state of being transported by the transport portion, and that includes a plurality of nozzles through which inks are ejected and thereby printing is performed onto the recording medium, the printing method comprising:
determining whether or not the transport of the recording medium is to be allowed, on the basis of an upper face position of the recording medium and a distance of the space.
